(19) United States
(12) Patent Application Publication
(10) Pub. No.: US 2011/0313793 A1
(43) Pub. Date: Dec. 22, 2011

(54) Fantasy Sports Insurance

(76) Inventors: Joseph Francis LaGiglia, New Lenox, IL (US); Philip Steven LaGiglia, New Lenox, IL (US); James Kent Lessen, Hoffman Estates, IL (US)

(21) Appl. No.: 12/817,356

(22) Filed: Jun. 17, 2010

(51) Int. Cl. G06Q 40/00

(52) U.S. Cl. 705/4

(57) ABSTRACT

A method of providing insurance to a fantasy sports participant includes receiving a request from the participant for an insurance policy covering an insured risk for an insured amount and providing an insurance policy to the participant covering the insured risk for the insured amount, in exchange for a premium. The participant owns a fantasy team and is in a fantasy league. The insured risk is at least one player on the fantasy team not playing for at least a portion of a fantasy season of the fantasy league. An amount of the premium is dependent on underwriting of the insured risk and the insured amount.

### BACKGROUND

Fantasy sports are competitions where each participant creates a fantasy team composed of athletes or players, and the fantasy teams compete against each other based on the performance of the athletes or players in real competitions, sporting events, contests, etc. The group of participants who will compete against each other join to form a fantasy league, and each participant may be referred to as a fantasy team owner. Fantasy leagues assign specific point values for the actions of the athletes during competitions, and then compare the sum of the points assigned to the actions of the athletes in each fantasy team, for example, during a season to determine a league champion of the fantasy league.

Fantasy leagues can be free or fee-based. In a fee-based fantasy league, fees are charged to fantasy team owners, such as an entry fee to participate in the fantasy league. Typically, the league champion of the fantasy league is awarded the sum of the entry fees, although other payout scenarios are possible. Fee-based fantasy leagues may also charge participants transactional fees for taking certain actions, such as trading players with other fantasy team owners, or replacing athletes in their fantasy teams.

Most fantasy sports correspond to a real sport; the players of the fantasy teams are all selected from athletes who are members of real teams competing in that sport. Team sports such as football, baseball, basketball, hockey, soccer, and cricket have popular corresponding fantasy sports. Fantasy sports can also correspond to individual player sports, such as golf, automobile racing, bowling, tennis, boxing, and wrestling.

Fantasy sports can also correspond to a non-sports group. For example, a fantasy sport could correspond to celebrities (“fantasy celebrity”). In fantasy celebrity, all the fantasy teams would be made up of one or more celebrities. Points may be awarded when players are involved in publicity promoting activities, such as appearing on the cover of a magazine, appearing on a television show, appearing in a movie, or hosting a live event. The fantasy season may be a specific period of time, such as 3 months. See, for example, http://celebrifantasy.com, FAQ tab.

Typically, all the athletes of fantasy teams of a fantasy league are selected from athletes of real teams of a single real sports league; in such a case the fantasy league has a corresponding real sports league. Fantasy leagues can correspond to real professional or amateur sports leagues. The athletes from a real league constitute the pool of players that may be selected as members of the fantasy teams. Examples of professional sports leagues with popular corresponding fantasy leagues include the NATIONAL FOOTBALL LEAGUE® (NFL®), MAJOR LEAGUE BASEBALL® (MLB®), the NATIONAL BASKETBALL ASSOCIATION® (NBA®), the NATIONAL HOCKEY LEAGUE® (NHL®), the UNION OF EUROPEAN FOOTBALL ASSOCIATIONS® (UEFA®), the PROFESSIONAL GOLF ASSOCIATION® (PGA®), MINOR LEAGUE BASEBALL®, MINOR LEAGUE HOCKEY® and the NATIONAL ASSOCIATION OF STOCK CAR AUTO RACING® (NASCAR®). Examples of amateur sports leagues with popular corresponding fantasy leagues include the NATIONAL COLLEGIATE ATHLETIC ASSOCIATION® (NCAA®) Football and NCAA® Basketball.

Participants create their fantasy teams within a fantasy league by selecting players from real teams or other groups of real people; this may be referred to as a fantasy draft. Participants in a fantasy league are typically required to select players that are members of the corresponding real league. While this creates a large pool of players from which to choose, only a small portion of these players are favored by fantasy team owners. For example, the same 30-40 players in the NFL are usually found in most fantasy football leagues. The most desirable players are those that are expected to generate large numbers of points based on their past performances. These players are in high demand since the majority of fantasy leagues allow a player to be a member of only a single fantasy team.

The success of a fantasy team will depend on its players, based on their performance. Three or four players of a fantasy team often account for the majority of the points accumulated by the fantasy team. Although trading players between fantasy teams is a common practice in fantasy sports, a fantasy team owner's success is largely dependent on the players chosen during the fantasy draft. Because of the importance of the fantasy draft, participants spend a significant amount of time and money analyzing the players in a fantasy league. For example, it is not unusual for fantasy football participants to spend $500 or more per season, including league fees, guidebooks, magazines, website subscriptions, and other fantasy football merchandise.

Injuries to the athletes can have a significant impact on the performance of fantasy teams. If a player is injured and unable to participate in competitions, that player will not produce points for the fantasy team. Since the most desirable athletes are almost always selected during the fantasy draft, an injury to a top point producing player can preclude the participant from having a realistic chance of becoming the league champion of the fantasy league. This was the case in 2008 when Tom Brady of the New England Patriots was injured in the first game of the NFL® season and missed the remainder of the NFL® season. Tom Brady was a very popular fantasy football player because of his previous performance and many fantasy team owners selected him for their fantasy teams. His injury was estimated to result in $150 million in losses to all fantasy football team owners that had selected him during the fantasy draft, because they were unable to win their fantasy leagues without his expected point production for their fantasy teams (“Tom Brady's Injury Will Reportedly Cost People $150 Million in Fantasy Football Losses”, Sep. 8, 2008 1:45 PM ET By Will Brinson, http://nfl.fanhouse.com/2008/09/08/tom-bradys-injury-will-reportedly-cost-people-150-million-in-f/).

Real sports team owners have long enjoyed the ability to purchase insurance policies to cover losses associated with injured players. Insurance gives owners a way to protect themselves in the event that a player on their team is injured and physically unable to play. These insurance policies function as typical insurance policies where the policyholder pays a premium that is related to the amount of coverage sought, the risk of various types and degrees of injury to the insured player, as well as the loss to the team owner associated various types and degrees of injury. Insurance companies determine the costs of their policies by predicting the likelihood that a claim will be made against their policies, and the probability of various amounts of a potential claim, based on analysis of the many variables associated with the risk being insured against, a process known as underwriting. Underwriting can take many forms and is well-known in the art. For example, an insurer underwriting an insurance policy covering a team owner's losses associated with an injured player would likely take into account the athlete's age, sport, position, and previous injuries. Other factors which may be important during underwriting such an insurance policy would be the likelihood of differing lengths of time the injured would be unable to pay, the details of the contract with the player (such as the duration of the employment contract, changes in pay to the athlete over the length of the contract, changes in pay to the athlete due to the occurrence of various events, risk sharing between the player and the team owner due to various events which could cause a loss, the potential of subrogation of a claim associated with the injury, the likelihood of litigation associated with the contract, revenue which would be unaffected or mildly affected by the injury, etc.).

Real sports team owners have a need for insurance because they could suffer enormous financial loss if a key player is unable to compete as expected. These losses could include a decrease in revenue resulting from the player's absence or indemnification of guaranteed compensation that is owed to the player, regardless of ability to play. Insurance policies allow owners to protect the financial investments that they have made in their teams from events that would deprive them of the services of their players, as well as possibly protect the expected additional revenue generated from that player's appearance and popularity.

### SUMMARY

In a first aspect, the invention is a method of providing insurance to a fantasy sports participant, including receiving a request from the participant for an insurance policy covering an insured risk for an insured amount and providing an insurance policy to the participant covering the insured risk for the insured amount, in exchange for a premium. The participant owns a fantasy team and is in a fantasy league. The insured risk is at least one player on the fantasy team not playing for at least a portion of a fantasy season of the fantasy league. An amount of the premium is dependent on underwriting of the insured risk and the insured amount.

In a second aspect, the invention is a computer program product for providing insurance to a fantasy sports participant having software encoded in computer-readable media. The software includes instructions that are operable when executed to receive a request from the participant for an insurance policy covering an insured risk for an insured amount and to provide an insurance policy to the participant covering the insured risk for the insured amount, in exchange for a premium. The participant owns a fantasy team, and is in a fantasy league. The insured risk is at least one player on the fantasy team not playing for at least a portion of a fantasy season of the fantasy league. An amount of the premium is dependent on underwriting of the insured risk and the insured amount.

The foregoing summary is illustrative only and is not intended to be in any way limiting. In addition to the illustrative aspects, embodiments, and features described above, further aspects, embodiments, and features will become apparent by reference to the drawings and the following detailed description.

### DEFINITIONS

The following definitions are included to provide a clear and consistent understanding of the specification and claims.

The term “fantasy sports” refers to competitions in which participants create virtual teams composed of athletes or players. Each virtual team accumulates points during real events, such as games, tournaments, races, sporting events or other activities, based on the performance of the players of the virtual team who participate in the events. The participants compete by creating virtual teams which accumulate more points than other virtual teams. Fantasy sports are also known as rotisserie sports, roto sports, and owner simulation sports.

A fantasy sport corresponds to a real sport or activity when all of the athletes or players of the corresponding fantasy sport are active athletes or players of the real sport or activity. This relationship may be expressed more simply by placing the term “fantasy” in front of the name of the sport. For example, fantasy football corresponds to real football, indicating that all the athletes of fantasy football teams are selected from active football players.

The term “fantasy” indicates that the object is associated with fantasy sports, and may be a virtual object which has characteristics of the real object within a fantasy sports competition. The term “real,” or the absence of the term “fantasy” may be used to more clearly indicate that the object is not a fantasy object.

The terms “participant” or “fantasy team owner” mean an individual who is participating in a fantasy sport competition.

The term “fantasy team” means a virtual team selected by a participant, composed of athletes or players, to compete against other fantasy teams in a fantasy sport competition.

The term “fantasy league” refers to a group of fantasy teams or participants that compete against each other in a fantasy sport competition. A fantasy league may have a single corresponding real league, such that all of the athletes or players of the corresponding fantasy league are players of the real league. An unlimited number of fantasy leagues can exist within a fantasy sport.

The term “fantasy draft” refers to selection of athletes or players to create the fantasy teams of a fantasy league.

The term “fantasy season” refers to the time period during which the fantasy teams of a fantasy league accumulate points.

The term “performance” refers to a series of actions carried out by an athlete or player during a period of time, or during an event, such as a game, a tournament, a race, a sporting event or other activity.

An insurance policy is a contract between a policyholder and an insurer. The insurance policy is an agreement in which the policyholder pays a premium to the insurer, and the insurer promises to pay an amount of money to the policyholder if a contingent event occurs. Once this contract is formed, the insurer is said to “issue the policy,” and the policyholder is said to “hold the policy.” The amount of money is referred to as the “insured amount” or “policy limit,” and the contingent event is referred to as the “insured risk.” A policyholder may make a claim against an insurance policy upon occurrence of the insured risk. The insurer will then pay the insured amount to the policyholder, which may also be referred to as “paying the claim”. If an amount of time has passed beyond which the insurance policy no longer requires the insurer to pay the policyholder and the insured risk has not occurred, then the insurance policy has “expired.”

The term “fantasy sports insurer” is a person or entity that sells fantasy sports insurance policies.

The term “underwriting” means the process of determining or selecting the likelihood of occurrence of the insured risk. A contract is not an insurance policy unless the amount of the premium is dependent on the likelihood of occurrence of the insured risk; therefore underwriting must occur for an insurer to issue an insurance policy. Accordingly, the term “underwriting” may also be used to refer to the process of determining the amount of the premium. Different insurers may require different premiums, for coverage of the same insured risk, even if they determine that the likelihood of occurrence of the insured risk is the same, since any profit they wish to make is also included in the premium.

The term “characteristics” refers to the information used in the underwriting process. Different characteristics may be given different “weight factors”, which is the relative effect given the characteristic during the underwriting process.

### BRIEF DESCRIPTION OF THE DRAWINGS

The invention can be better understood with reference to the following drawings and description.

FIG. 1 illustrates a method of providing insurance to a fantasy sports participant.

### DETAILED DESCRIPTION

The present invention makes use of the discovery of a system for fantasy sports participants to protect their investment in a fantasy team in the event that a player on their fantasy team does not play (or have an opportunity to generate points) during a portion or portions of the fantasy season, for example, due to injury, death or disqualification of the player or players, referred to as fantasy sports insurance.

Participants may purchase a fantasy sports insurance policy from a fantasy sports insurer. A fantasy sports insurance policy will protect a fantasy team owner in the event that one or more athletes on the fantasy team are unable to play and thereby generate points. Preferably, the fantasy sports insurance policy requires that the reason for being unable to play is due to any one of a limited number of reasons, which may include, for example injury, death, incarceration, disqualification of the player, disappearance, refusal of the player to participate, employment contract dispute, lockout, natural disaster, weather, illness and criminal act. They may also place additional restrictions on the insured risk and/or the insurance policy, such as requiring that the policy be purchased before or after a specific time period or portion of the fantasy season, and that the insured risk occur during a specific portion of the fantasy season. Furthermore, the fantasy sports insurer may require that the participant is in a specific fantasy league, or alternatively a fantasy sports league may require all participants to have a fantasy insurance policy, for example by including a premium in the entry fee for the fantasy league.

The fantasy sports insurance policies will return the insured amount, such as the participants' financial investments in their fantasy team for a single fantasy season, in return for the payment of a premium. Fantasy sports insurers will determine appropriate fantasy sports insurance premiums by underwriting the desired fantasy sports insurance policy coverage.

Fantasy sports insurance has a number of unique characteristics that distinguish it from other types of insurance. The policyholder has no legal interest and/or financial interest in the player or players who is insured. A fantasy team owner may obtain the exclusive right to have an athlete on their fantasy team by selecting the player in a fantasy draft, trading with another fantasy team owner, or by selecting a replacement player that was not selected by another participant. These rights only exist within the fantasy league in which the participant is a member and have no value or implication outside of the fantasy league. Accordingly, the policyholder has no influence on the likelihood of occurrence of the insured risk.

There may be many fantasy sports insurance policies held by many different participants, all of which have exactly the same insured risk. This results from the fact that there may be multiple leagues which are all of the same type, that is the players are selected from exactly the same group of people.

The probability of occurrence of the insured risk, unlike roll dice or selecting card from a deck of cards, cannot be exactly determined, regardless of the amount of information obtained or the time available for underwriting. This is because the insured risk involves specific people and real events, and all the different characteristics available for use in underwriting. Typically, underwriting is carried out by studying past events, correlating various characteristics of the insured risk with past events, and selecting characteristics that have a causal relationship with the past events. These are a normal part of traditional underwriting.

The insured risk is not tied to a virtual object or virtual event. Players are real, and the insured risk is a real event involving real objects (typically people). This is different than insuring a virtual object, such as a character controlled by someone in a computer game or simulation. In most cases, the occurrence of the insured risk of a fantasy sports insurance policy is public information reported by news agencies and is available from magazines, newspapers, and online information sources.

Fantasy sports insurers may offer fantasy sports insurance to fantasy team owners that have exclusive rights to an athlete in a fantasy league. Policyholders may be required to demonstrate that the players covered by the insurance policy are members of the participant's fantasy team, to prevent uninterested parties from speculating on the possibility of an athlete getting injured.

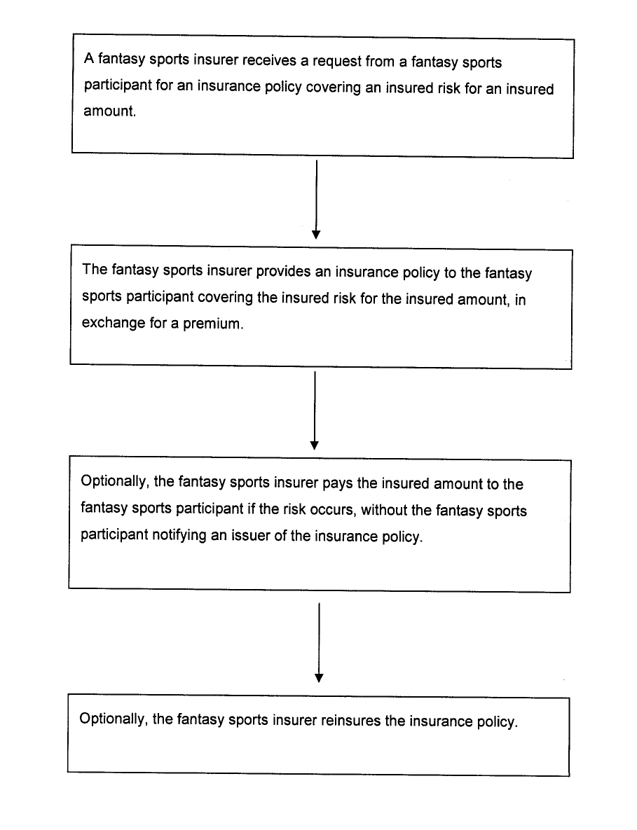

FIG. 1 illustrates a method of providing insurance to a fantasy sports participant. A fantasy sports insurer receives a request from a participant for an insurance policy covering an insured risk for an insured amount. The fantasy sports insurer provides an insurance policy to the participant covering the insured risk for the insured amount, in exchange for a premium. Optionally, the fantasy sports insurer pays the insured amount to the participant if the risk occurs, without the participant notifying an issuer of the insurance policy. Optionally, the fantasy sports insurer reinsures the insurance policy.

Fantasy sports participants may spend a considerable amount of money to participate in their fantasy leagues throughout a fantasy season. This financial investment can be protected by fantasy sports insurance in the event that one or more players on the fantasy team owner's fantasy team are injured and unable to play. The financial investment may include any league entry fees, transaction fees, and external fantasy sports expenses such as fantasy sports books, fantasy sports magazines, or fantasy sports website subscriptions that he expects to incur for the duration of the specific fantasy season.

A fantasy sports insurer may offer a number of different fantasy sports insurance policy options. One insurance policy option would be insuring a single athlete in the event that the athlete misses a set number of games (or portion or portions of a fantasy season) during the fantasy season. Another policy option would be insuring multiple athletes in the event that the athletes miss a combined set number of games (or portion or portions of a fantasy season) during the season due to injury.

An insurer may offer policies covering multiple athletes, which may be a way to reduce the insurance premium for a fantasy team owner. An insurance policy that is triggered by multiple events has a lower probability of being triggered, which corresponds to a lower premium. Multiple-athlete insurance policies may also be attractive to fantasy team owners because they allow a fantasy team owner to insure the athletes that will be responsible for generating the majority of the points which are anticipated from the fantasy team with a single policy. Furthermore, the fantasy sports insurance policy may also include not becoming the league champion as part of the insured risk, thereby requiring that the policyholder actually suffer a loss in order to receive payment.

Fantasy sports insurance policies may only be offered for specific portions of a fantasy season. Fantasy sports insurers may require a policy to be purchased before the start of the real season. Alternatively, fantasy sports insurers may set a deadline after which an insurance policy will no longer be offered.

Fantasy sports insurers may operate physical brick-and-mortar stores and transact with fantasy team owners that visit their stores. Insurers could also sell insurance policies over the telephone. Fantasy sports insurers may offer insurance via a transaction carried out through the internet. Fantasy sports insurers may also offer insurance through mobile devices that are connected to the internet, such as smartphones, PDAs, or other similar devices.

Underwriting will entail an analysis of the desired coverage sought and the characteristics of the athlete that will be the subject of the fantasy sports insurance policy. Underwriting may take into account any number of variables to analyze the risk.

Fantasy sports insurance underwriting involves identifying characteristics that are relevant to insured risk. These characteristics will vary based on the particular sport that the athlete plays. For example, one reason why an NFL® football player is more likely to be injured than a MLB® baseball player is because football is a collision sport where competitors purposely collide with each other.

The relevant characteristics considered for a given sport may vary depending on the position played by the athlete. Different positions provide different opportunities for injury and may also involve different mechanical motions that will affect an athlete's potential for injury. For example, there are additional characteristics to consider when analyzing the risk of injury to a NFL® quarterback as compared to the risk of injury to a NFL® receiver such as the quarterback's career passing attempts and the times he has been sacked in his career. Quarterbacks are also at an increased risk of injury to their arms and shoulders due to their repetitive throwing motions used to pass the football.

Relevant characteristics for NFL® football players include the position the athlete plays, the current age of the athlete, the total number of games played by the athlete in his career, the total number of rushing carries an athlete has over his career, any prior games missed due to injury, the total games played since the athlete's previous surgery, if any, and the total number of downs played. For NFL® quarterbacks, relevant characteristics additionally include the total number of times the quarterback is sacked in his career and the total number of passes attempted in the quarterback's career. For NFL® receivers and running backs, relevant characteristics additionally include the total number of passes received in the athlete's career.

Some risk characteristics will not be applicable to all athletes within a given sport. In MLB®, there is a quantifiable difference in the likelihood of injury to pitchers depending on if the pitcher plays in the American League® or the National League®. This is in part due to the fact that pitchers in the National League® act as hitters when their team is on offense while pitchers in the American League® do not act as hitters when their team is on offense. Pitchers that participate in both offense and defense are at a higher risk of being injured because they are involved in more total plays and are exposed to more opportunities to suffer injuries. There is no similar risk disparity for position players (non-pitchers) in MLB®, so the league that a position player is in would not be taken into account when analyzing a position player's risk of injury.

Relevant characteristics for MLB® baseball players include the position the athlete plays, the current age of the athlete, the total innings pitched or played in the athlete's career, any prior games missed due to injury, and the total games played since the athlete's previous surgery, if any. For MLB® position players, relevant characteristics additionally include the athlete's career at bats. For MLB® pitchers, relevant characteristics include the total number of pitches thrown in the athlete's career and which MLB® league the pitcher plays in.

Risk characteristics may be related to the real team for which the athlete plays. These team-based factors could include the team itself, the coach, or the city where the team is located. For example, in the NFL® some teams primarily use a single running back for the majority of running opportunities while others use a running back “platoon” in which multiple running backs share the running opportunities. The platoon system has the effect of reducing his likelihood of injury since he has fewer running opportunities where he might suffer an injury.

Risk characteristics do not necessarily need to be linked with the physical traits of the athlete. In NASCAR®, a race car driver's age, previous races missed due to injury, average number of races the driver competes in per year, and the total number of laps driven in the driver's career would be relevant risk characteristics. Non-physical characteristics that are relevant to analyzing a driver's risk of injury include the team that the driver races for, the car make and model that the driver drives, the driver's average finish in races over his career, and the driver's average speed over the past three years.

Fantasy sports insurers may consider some relevant risk characteristics to be of more importance than others when analyzing the likelihood that an athlete will be injured. For example, in the NFL® an athlete's age is more indicative of his likelihood of injury when the athlete is a running back than when he is a quarterback. A fantasy sports insurance underwriter would thus assign a greater weight to a running back's age than a quarterback's age when determining the two athletes' likelihood of injury.

Fantasy sports insurance underwriters determine an appropriate premium for the desired insurance policy after analyzing the specified coverage amount and the relevant risk characteristics of the athlete to be insured. Underwriting methods are well known in the art of insurance and involve some analysis of the likelihood of the risk occurring. Simply charging policyholders a set percentage of their desired coverage amount as their premium does not rise to the level of underwriting because it does not take risk into account.

Underwriting a fantasy sports insurance policy can be done by hand using an underwriting table. An underwriter must determine the relevant characteristics to include in an underwriting system and then assign relative values for each of these characteristics. The underwriter would then enter the relevant data for each athlete into the underwriting table. The underwriter can calculate an insurance premium by analyzing the coverage sought and the athletes to be insured.

Underwriting a fantasy sports insurance policy may be done by using a computer. A human underwriter or actuary may initially determine the relevant characteristics to include in an underwriting system and will provide the relative values for each of these characteristics. A programmer will then enter the relevant data for each athlete into an underwriting database. Once a database of athlete data and relative underwriting characteristics has been created, the underwriting process can be automated. An insurance broker could use a computer running an underwriting program to enter the desired coverage sought and the athletes to be insured. The program would then calculate the appropriate insurance premium and output this value.

Alternatively, the human insurance broker can be eliminated by offering an interactive website over the internet that allows a fantasy sports participant to enter his desired coverage information and receive a quote for an insurance premium. A fantasy team owner seeking fantasy sports insurance for athletes on his or her fantasy team can input the desired coverage amounts and covered players on a website. The information entered would then be used by an underwriting computer program to calculate an appropriate insurance premium.

A fantasy team owner that is satisfied with the premium offered would then purchase the fantasy sports insurance policy by paying that premium. Preferably, the fantasy team owner will pay the insurance premium in one transaction. Alternately, the fantasy team owner may divide the premium into multiple payments. A fantasy team owner purchasing insurance coverage over the internet could have the option to pay with credit card, by transferring funds from a bank account, or by using internet-based payment systems such as PayPal™. A fantasy sports insurance policy may not go into effect until the premium has been paid in full.

A fantasy sports insurance policy will pay the fantasy team owner the policy coverage amount if the insured athlete is injured and unable to play in accordance with the terms of the fantasy sports insurance policy. The fantasy sports insurer will monitor the injury reports of all sports leagues where insurance is offered to determine which athletes miss games due to injury. It is not uncommon for athletes to miss games for reasons other than injury. An athlete could be unable to participate as expected because of being suspended, attending to personal or family issues, or simply taking a game off to rest. A fantasy sports insurer may choose to include games missed for reasons other than injury in their insurance policies.

A fantasy sports insurer will pay fantasy team owners in accordance with their insurance policies at the end of the fantasy season if an athlete covered by their policy misses the number of games due to injury as specified in the insurance policy. A policy may be triggered sooner than the end of the season and the fantasy sports insurer may optionally choose to pay the policyholder before the fantasy season concludes. Payment can take many forms such as drawing a check, transferring funds to a bank account, making a payment to an internet-based payment system such as PayPal™, or any other acceptable method of transferring funds. Alternatively, the fantasy insurer may not actually pay the policyholder, but provide a credit toward a future entry fee, a discount toward a future entry fee, or provide points not earned by a player to the fantasy team owner.

Fantasy sports insurers may offer additional fantasy sports insurance policies to fantasy team owners whose original policies have been triggered. A fantasy team owner that has lost a player on his fantasy team due to injury will likely incur additional expenses that were not contemplated when the fantasy team owner purchased the initial insurance policy. The fantasy team owner will also likely have to modify his fantasy team in order to offset the loss in point production from the injured athlete. Fantasy sports insurers may offer subsequent insurance policies after the original time frame for purchasing a fantasy sports insurance policy has closed. These subsequent policies would cover previously uninsured athletes and the additional expenses that were not previously part of the insurance coverage.

The funds that fantasy sports insurers have collected as insurance premiums from policyholders but not yet paid out are available for investment. Fantasy sports insurers can invest these funds as a way to earn additional profits.

Fantasy sports insurers may seek reinsurance to protect their contractual obligations to fantasy team owners that have purchased fantasy sports insurance. Reinsurance allows insurance companies to transfer the risk of having to pay a large amount of money if a number of policies are triggered simultaneously. Reinsurers act as traditional insurance companies that assume the financial risks that may be suffered by other insurance companies. Reinsurance would be particularly attractive to fantasy sports insurers since there are only a small number of athletes in each fantasy sport that are expected to be popular and chosen by the majority of fantasy team owners. Fantasy sports insurers should expect that these particularly popular athletes will be covered in many policies bought by fantasy team owners. Fantasy insurers could potentially face a very large financial obligation in the event that a particularly popular athlete is injured an unable to play. Fantasy sports insurers could protect themselves from this potential financial obligation by purchasing reinsurance.

### EXAMPLES

### Example 1

### Investment in Fantasy Sports

A fantasy sports participant could have the following investment in his fantasy football league:

| Expense | Amount |
|---|---|
| Fantasy League Entry Fee | $200 |
| Fantasy League Transaction Fees | $20 |
| Fantasy Football Draft Kit | $40 |
| Fantasy Football Website Subscription | $60 |
| Fantasy Football Magazine | $8 |
| TOTAL | $328 |

The fantasy sports participant seeking fantasy sports insurance would seek a policy that would reimburse his $328 in fantasy season expenses in the event that one or more players on his team are injured and unable to play.

### Example 2

### Sample Fantasy Sports Insurance Policies

A fantasy sports insurer may offer the following insurance policies for fantasy football:

| Number of Athletes Insured | Triggering Conditions |
|---|---|
| One | Miss 9 or more of the first 15 games of the |
| | NFL ® season due to injury |
| Two | Miss 14 or more combined NFL ® regular |
| | season games out of the combined next |
| | 24 NFL ® regular season games due to |
| | injury |
| Three | Miss 20 or more combined NFL ® regular |
| | season games out of the combined next |
| | 33 NFL ® regular season games due to |
| | injury |

Similar policies may be offered for other fantasy sports. Each policy condition will have to be adjusted for the number of games in each real sports league.

Fantasy sports insurers need to take into account the fact that players sometimes do not play games that are late in the real sports season. It is not uncommon for athletes to voluntarily not play late-season games in order to rest before the league playoffs. Many fantasy leagues account for this by limiting the fantasy season to a number of games that is less than the real season length. Fantasy sports insurers will also want to factor this into their policy options when deciding the number of games missed necessary trigger insurance coverage.

### Example 3

### Fantasy Football

A fantasy football participant, Owner A, creates the following fantasy football team:

| Position | Player |
|---|---|
| Quarterback | Chad Pennington |
| Running back | Matt Forte |
| Running back | Marion Barber |
| Running back | Darren McFadden |
| Full back | Jason McKie |
| Wide Receiver | Larry Fitzgerald |
| Wide Receiver | Devon Hester |
| Wide Receiver | Johnny Knox |
| Tight End | Greg Olson |
| Tight End | Desmond Clark |

Owner A elects to purchase a fantasy sports insurance policy that covers a single player who misses 9 or more of the first 15 games of the NFL® regular season due to injury. The fantasy sports insurance policy will be available for purchase before week 1 of the NFL® regular season. Owner A chooses Chad Pennington to be the single player covered by the policy.

Owner A indicates in his application for fantasy sports insurance that his fantasy league costs are $200.00. Based on $200.00 of coverage, the choice of policy, and the selection of Chad Pennington as the covered player, appropriate underwriting would produce a premium for this policy of $25.00.

The NFL® players on Owner A's team miss the following games due to injury:

| Player | Games Missed Due to Injury |
|---|---|
| Chad Pennington | 12 (Week 4 to Week 17) |
| Matt Forte | 0 |
| Marion Barber | 1 |
| Darren McFadden | 4 |
| Jason McKie | 0 |
| Larry Fitzgerald | 0 |
| Devon Hester | 3 |
| Johnny Knox | 1 |
| Greg Olson | 0 |
| Desmond Clark | 0 |

Owner A's insurance policy would be triggered in this Example. The policy insured against Chad Pennington missing 9 or more of the first 15 games due to injury. Chad Pennington was injured and missed 12 games due to injury, which is greater than the minimum number of games missed due to injury necessary to trigger the policy. The fantasy sports insurance would pay Owner A $200.00 in accordance with the terms of his policy.

### Example 4

### Fantasy Football

A fantasy football participant, Owner B, creates the following fantasy football team:

| Position | Player |
|---|---|
| Quarterback | Aaron Rodgers |
| Running Back | Adrian Peterson |
| Running Back | Brian Westbrook |
| Running Back | Beanie Wells |
| Running Back | Tim Hightower |
| Wide Receiver | Steve Breaston |
| Wide Receiver | Rodney Wright |
| Wide Receiver | Marty Booker |
| Tight End | Bo Scaife |
| Tight End | Ben Patrick |

Owner B elects to purchase a fantasy sports insurance policy that covers two players who combined miss 14 or more NFL® regular season games out of the combined next 24 NFL® regular season games due to injury. The fantasy sports insurance policy will be available for purchase before week 4 of the NFL® regular season. Owner B chooses Bo Scaife and Brian Westbrook to be the two players covered by the policy.

Owner B indicates in her application for fantasy sports insurance that her fantasy league costs are $200.00. Based on $200.00 of coverage, the choice of policy, and the selection of Bo Scaife and Brian Westbrook as the covered players, appropriate underwriting would produce a premium for this policy of $20.00.

The NFL® players on Owner B's team miss the following games due to injury:

| Player | Games Missed Due to Injury |
|---|---|
| Aaron Rodgers | 0 |
| Adrian Peterson | 0 |
| Brian Westbrook | 6 |
| Beanie Wells | 0 |
| Tim Hightower | 0 |
| Steve Breaston | 0 |
| Rodney Wright | 0 |
| Marty Booker | 0 |
| Bo Scaife | 2 |
| Ben Patrick | 0 |

Owner B's insurance policy would not be triggered in this Example. The policy insured against Bo Scaife and Brian Westbrook missing a combined 14 or more games of the next combined 24 games due to injury. Bo Scaife was injured and missed 2 games due to injury. Brian Westbrook was injured and missed 6 games due to injury. The insurance policy was not triggered because the players missed a combined 8 games due to injury, which is less than the minimum number of games missed due to injury necessary to trigger the policy. The fantasy sports insurance would not pay Owner B in accordance with the terms of his policy

### Example 5

### Fantasy Football

A fantasy football participant, Owner C, creates the following fantasy football team:

| Position | Player |
|---|---|
| Quarterback | Peyton Manning |
| Running Back | Leon Washington |
| Running Back | Garret Wolfe |
| Wide Receiver | Dwayne Bowe |
| Wide Receiver | Donald Driver |
| Wide Receiver | Anquan Boldin |
| Wide Receiver | Justin Gage |
| Tight End | Donald Lee |
| Placekicker | Mason Crosby |

Owner C elects to purchase a fantasy sports insurance policy that covers three players who combined miss 20 or more NFL® regular season games out of the combined next 33 NFL® regular season games due to injury. The fantasy sports insurance policy will be available for purchase before week 5 of the NFL® regular season. Owner C chooses Leon Washington, Dwayne Bowe, and Garret Wolfe to be the three players covered by the policy.

Owner C indicates in his application for fantasy sports insurance that his fantasy league costs are $200.00. Based on $200.00 of coverage, the choice of policy, and the selection of Leon Washington, Dwayne Bowe, and Garret Wolfe as the covered players, appropriate underwriting would produce a premium for this policy of $17.00.

The NFL® players on Owner C's team miss the following games due to injury:

| Player | Games Missed Due to Injury |
|---|---|
| Peyton Manning | 0 |
| Leon Washington | 8 |
| Garret Wolfe | 8 |
| Dwayne Bowe | 4 |
| Donald Driver | 0 |
| Anquan Boldin | 1 |
| Justin Gage | 4 |
| Donald Lee | 0 |
| Mason Crosby | 0 |

Owner C's insurance policy would be triggered in this Example. The policy insured against Leon Washington, Dwayne Bowe, and Garret Wolfe missing a combined 20 or more games of the next combined 33 games due to injury. Leon Washington was injured and missed 8 games due to injury. Dwayne Bowe was injured and missed 4 games due to injury. Garret Wolfe was injured and missed 8 games due to injury. The insurance policy was triggered because the players missed a combined 20 games due to injury, which is the minimum number of games missed due to injury necessary to trigger the policy. The fantasy sports insurance would pay Owner C $200.00 in accordance with the terms of his policy.

### Example 6

### Fantasy Baseball

A fantasy baseball participant, Owner D, creates the following fantasy baseball team:

| Position | Player |
|---|---|
| First Base | Albert Pujols |
| Second Base | Ian Kinsler |
| Third Base | Joe Crede |
| Shortstop | Derek Jeter |
| Catcher | Geovany Soto |
| Outfielder | Matt Kemp |
| Outfielder | Justin Upton |
| Outfielder | Ichiro Suzuki |
| Starting Pitcher | C. C. Sabathia |
| Starting Pitcher | Chris Carpenter |
| Relief Pitcher | Mariano Rivera |
| Relief Pitcher | Carlos Marmol |

Owner D elects to purchase a fantasy sports insurance policy that covers a single player who misses 55 or more games of the MLB® regular season due to injury while on the Disabled List. The fantasy sports insurance policy will be available for purchase before week 5 of the MLB® regular season. Owner D chooses Joe Crede to be the player covered by the policy.

Owner D indicates in her application for fantasy sports insurance that her fantasy league costs are $200.00. Based on $200.00 of coverage, the choice of policy, and the selection of Joe Crede as the covered player, appropriate underwriting would produce a premium for this policy of $25.00.

The MLB® players on Owner D's team miss the following games due to injury while on the Disabled List:

| Player | Games Missed Due to Injury |
|---|---|
| Albert Pujols | 0 |
| Ian Kinsler | 17 |
| Joe Crede | 72 |
| Derek Jeter | 0 |
| Geovany Soto | 31 |
| Matt Kemp | 0 |
| Justin Upton | 20 |
| Ichiro Suzuki | 15 |
| C. C. Sabathia | 0 |
| Chris Carpenter | 35 |
| Mariano Rivera | 0 |
| Carlos Marmol | 0 |

Owner D's insurance policy would be triggered in this Example. The policy insured against Joe Crede missing 55 or more games due to injury. Joe Crede was injured and missed 72 games due to injury, which is greater than the minimum number of games missed due to injury necessary to trigger the policy. The fantasy sports insurance would pay Owner D $200.00 in accordance with the terms of her policy.

### Example 7

### Fantasy Baseball

A fantasy baseball participant, Owner E, creates the following fantasy baseball team:

| Position | Player |
|---|---|
| First Base | Prince Fielder |
| Second Base | Robinson Cano |
| Third Base | David Wright |
| Shortstop | Troy Tulowitzki |
| Catcher | Brian McCann |
| Outfielder | Carl Crawford |
| Outfielder | Grady Sizemore |
| Outfielder | Gary Sheffield |
| Starting Pitcher | Felix Hernandez |
| Starting Pitcher | Zack Greinke |
| Relief Pitcher | Jonathan Papelbon |
| Relief Pitcher | Mariano Rivera |

Owner E elects to purchase a fantasy sports insurance policy that covers two players who combined miss 85 or more MLB® regular season games due to injury while on the Disabled List. The fantasy sports insurance policy will be available for purchase before week 1 of the MLB® regular season. Owner E chooses Grady Sizemore and Gary Sheffield to be the players covered by the policy.

Owner E indicates in his application for fantasy sports insurance that his fantasy league costs are $200.00. Based on $200.00 of coverage, the choice of policy, and the selection of Grady Sizemore and Gary Sheffield as the covered players, appropriate underwriting would produce a premium for this policy of $20.00.

The MLB® players on Owner E's team miss the following games due to injury while on the Disabled List:

| Player | Games Missed Due to Injury |
|---|---|
| Prince Fielder | 0 |
| Robinson Cano | 0 |
| David Wright | 16 |
| Troy Tulowitzki | 0 |
| Brian McCann | 16 |
| Carl Crawford | 0 |
| Grady Sizemore | 53 |
| Gary Sheffield | 62 |
| Felix Hernandez | 0 |
| Zack Greinke | 0 |
| Jonathan Papelbon | 0 |
| Mariano Rivera | 0 |

Owner E's insurance policy would be triggered in this Example. The policy insured against Grady Sizemore and Gary Sheffield missing a combined 85 or more games due to injury. Grady Sizemore missed 53 games due to injury. Gary Sheffield missed 62 games due to injury. The insurance policy is triggered because the two players missed a combined 115 games due to injury, which is greater than the minimum number of games missed due to injury necessary to trigger the policy. The fantasy sports insurance would pay Owner E $200.00 in accordance with the terms of his policy.

### Example 8

### Fantasy Baseball

A fantasy baseball participant, Owner F, creates the following fantasy baseball team:

| Position | Player |
|---|---|
| First Base | Miguel Cabrera |
| Second Base | Chase Utley |
| Third Base | Alex Rodriguez |
| Shortstop | Alexei Ramirez |
| Catcher | Joe Mauer |
| Outfielder | Jacoby Ellsbury |
| Outfielder | Vladimir Guerrero |
| Outfielder | Carlos Quentin |
| Starting Pitcher | Matt Cain |
| Starting Pitcher | Josh Beckett |
| Relief Pitcher | Bobby Jenks |
| Relief Pitcher | Ryan Franklin |

Owner F elects to purchase a fantasy sports insurance policy that covers three players who combined miss 110 or more MLB® regular season games due to injury while on the Disabled List. The fantasy sports insurance policy will be available for purchase before week 1 of the MLB® regular season. Owner F chooses Alex Rodriguez, Joe Mauer, and Matt Cain to be the players covered by the policy.

Owner F indicates in her application for fantasy sports insurance that her fantasy league costs are $200.00. Based on $200.00 of coverage, the choice of policy, and the selection of Alex Rodriguez, Joe Mauer, and Matt Cain as the covered players, appropriate underwriting would produce a premium for this policy of $17.00.

The MLB® players on Owner F's team miss the following games due to injury while on the Disabled List:

| Player | Games Missed Due to Injury |
|---|---|
| Miguel Cabrera | 0 |
| Chase Utley | 0 |
| Alex Rodriguez | 42 |
| Alexei Ramirez | 0 |
| Joe Mauer | 35 |
| Jacoby Ellsbury | 0 |
| Vladimir Guerrero | 62 |
| Carlos Quentin | 55 |
| Matt Cain | 0 |
| Josh Beckett | 15 |
| Bobby Jenks | 0 |
| Ryan Franklin | 0 |

Owner F's insurance policy would not be triggered in this Example. The policy insured against Alex Rodriguez, Joe Mauer, and Matt Cain missing a combined 110 or more games due to injury. Alex Rodriguez missed 42 games due to injury. Joe Mauer missed 35 games due to injury. Matt Cain missed 0 games due to injury. The insurance policy is not triggered because the three players missed a combined 77 games due to injury, which is less than the minimum number of games missed due to injury necessary to trigger the policy. The fantasy sports insurance would not pay Owner E in accordance with the terms of her policy.

### Example 9

### Fantasy Basketball

A fantasy basketball participant, Owner G, creates the following fantasy basketball team:

| Position | Player |
|---|---|
| Point Guard | T. J. Ford |
| Shooting Guard | Kobe Bryant |
| Shooting Guard | Allen Iverson |
| Small Forward | Corey Maggette |
| Small Forward | Richard Hamilton |
| Power Forward | Tyrus Thomas |
| Power Forward | Dwight Howard |
| Center | Yao Ming |

Owner G elects to purchase a fantasy sports insurance policy that covers a single player who misses 30 or more games of the NBA® regular season due to injury. The fantasy sports insurance policy will be available for purchase through week 7 of the NBA® regular season. Owner G chooses Yao Ming to be the player covered by the policy.

Owner G indicates in his application for fantasy sports insurance that his fantasy league costs are $200.00. Based on $200.00 of coverage, the choice of policy, and the selection of Yao Ming as the covered player, appropriate underwriting would produce a premium for this policy of $31.00.

The NBA® players on Owner G's team miss the following games due to injury:

| Player | Games Missed Due to Injury |
|---|---|
| T. J. Ford | 0 |
| Kobe Bryant | 12 |
| Allen Iverson | 0 |
| Corey Maggette | 0 |
| Richard Hamilton | 0 |
| Tyrus Thomas | 10 |
| Dwight Howard | 0 |
| Yao Ming | 72 |

Owner G's insurance policy would be triggered in this Example. The policy insured against Yao Ming missing 30 or more games due to injury. Yao Ming was injured and missed 72 games due to injury, which is greater than the minimum number of games missed due to injury necessary to trigger the policy. The fantasy sports insurance would pay Owner G $200.00 in accordance with the terms of his policy.

### Example 10

### Fantasy Basketball

A fantasy basketball participant, Owner H, creates the following fantasy basketball team:

| Position | Player |
|---|---|
| Point Guard | Derrick Rose |
| Shooting Guard | Dwayne Wade |
| Shooting Guard | LeBron James |
| Small Forward | Zach Randolph |
| Small Forward | Luol Deng |
| Power Forward | Joakim Noah |
| Power Forward | Derrick Anderson |
| Center | Eddie Curry |

Owner H elects to purchase a fantasy sports insurance policy that covers two players who miss a combined 50 or more games of the NBA® regular season due to injury. The fantasy sports insurance policy will be available for purchase through week 7 of the NBA® regular season. Owner H chooses Eddie Curry and Derrick Anderson to be the players covered by the policy.

Owner H indicates in her application for fantasy sports insurance that her fantasy league costs are $200.00. Based on $200.00 of coverage, the choice of policy, and the selection of Eddie Curry and Derrick Anderson as the covered players, appropriate underwriting would produce a premium for this policy of $22.00.

The NBA® players on Owner H's team miss the following games due to injury:

| Player | Games Missed Due to Injury |
|---|---|
| Derrick Rose | 4 |
| Dwayne Wade | 0 |
| LeBron James | 0 |
| Zach Randolph | 0 |
| Luol Deng | 4 |
| Joakim Noah | 8 |
| Derrick Anderson | 15 |
| Eddie Curry | 28 |

Owner H's insurance policy would not be triggered in this Example. The policy insured against Eddie Curry and Derrick Anderson missing a combined 50 or more games due to injury. Eddie Curry missed 28 games due to injury. Derrick Anderson missed 15 games due to injury. The insurance policy is not triggered because the two players missed a combined 43 games due to injury, which is less than the minimum number of games missed due to injury necessary to trigger the policy. The fantasy sports insurance would not pay Owner H in accordance with the terms of her policy.

### Example 11

### Fantasy Basketball

A fantasy basketball participant, Owner I, creates the following fantasy basketball team:

| Position | Player |
|---|---|
| Point Guard | Tony Parker |
| Shooting Guard | Michael Redd |
| Shooting Guard | Ray Allen |
| Small Forward | Carmelo Anthony |
| Small Forward | Kevin Durant |
| Power Forward | Dirk Nowitzki |
| Power Forward | Josh Smith |
| Center | Greg Oden |

Owner I elects to purchase a fantasy sports insurance policy that covers three players who miss a combined 85 or more games of the NBA® regular season due to injury. The fantasy sports insurance policy will be available for purchase through week 7 of the NBA® regular season. Owner I chooses Michael Redd, Greg Oden, and Ray Allen to be the players covered by the policy.

Owner I indicates in his application for fantasy sports insurance that his fantasy league costs are $200.00. Based on $200.00 of coverage, the choice of policy, and the selection of Michael Redd, Greg Oden, and Ray Allen as the covered players, appropriate underwriting would produce a premium for this policy of $17.00.

The NBA® players on Owner I's team miss the following games due to injury:

| Player | Games Missed Due to Injury |
|---|---|
| Tony Parker | 0 |
| Michael Redd | 48 |
| Ray Allen | 0 |
| Carmelo Anthony | 0 |
| Kevin Durant | 0 |
| Dirk Nowitzki | 0 |
| Josh Smith | 0 |
| Greg Oden | 66 |

Owner I's insurance policy would be triggered in this Example. The policy insured against Michael Redd, Greg Oden, and Ray Allen missing a combined 85 or more games due to injury. Michael Redd missed 48 games due to injury. Greg Oden missed 66 games due to injury. Ray Allen missed 0 games due to injury. The insurance policy is triggered because the three players missed a combined 114 games due to injury, which is greater than the minimum number of games missed due to injury necessary to trigger the policy. The fantasy sports insurance would pay Owner I $200.00 in accordance with the terms of his policy.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A method of providing insurance to a fantasy sports participant, comprises:
receiving a request from the participant for an insurance policy covering an insured risk for an insured amount; and
providing an insurance policy to the participant covering the insured risk for the insured amount, in exchange for a premium;
wherein the participant owns a fantasy team, and is in a fantasy league,
the insured risk is at least one player on the fantasy team not playing for at least a portion of a fantasy season of the fantasy league, and
an amount of the premium is dependent on underwriting of the insured risk and the insured amount.

2. The method of claim 1, wherein the fantasy league has a corresponding real sports league.

3. The method of claim 2, wherein the real sports league is a professional sports league.

4. The method of claim 3, wherein the sport of the real sports league is selected from the group consisting of football, baseball, basketball and hockey.

5. The method of claim 1, wherein the fantasy league is a fantasy sports league of a sport selected from the group consisting of football, basketball, baseball, hockey, soccer, cricket, golf, automobile racing, bowling, tennis, boxing and wrestling.

6. The method of claim 1, wherein the insured risk is the at least one player on the fantasy team not playing due to injury or death.

7. The method of claim 1, wherein the insured amount is at most an entry fee paid by the participant to participate in the fantasy league.

8. The method of claim 1, wherein the insured risk is the at least one player on the fantasy team not playing and the participant not becoming a champion of the fantasy league.

9. The method of claim 1, wherein the insurance policy is provided during a first half of the fantasy season.

10. The method of claim 9, wherein the insurance policy is provided no later than a third week of the fantasy season.

11. The method of claim 1, wherein the request for the insurance policy is received during a fantasy draft of the fantasy league.

12. The method of claim 1, wherein the premium is paid together with an entry fee to participate in the fantasy league.

13. The method of claim 1, wherein the insured risk is at least two players on the fantasy team not playing.

14. The method of claim 1, wherein the insured risk is one, two or three players on the fantasy team not playing.

15. The method of claim 14, wherein the insured risk is two or three players on the fantasy team not playing for a specified combined period of time.

16. The method of claim 1, wherein the insurance policy expires before the end of the fantasy season.

17. The method of claim 1, wherein the fantasy league has a corresponding real sports league selected from the group consisting of the NATIONAL FOOTBALL LEAGUE® (NFL®), MAJOR LEAGUE BASEBALL® (MLB®), the NATIONAL BASKETBALL ASSOCIATION® (NBA®), the NATIONAL HOCKEY LEAGUE® (NHL®), the UNION OF EUROPEAN FOOTBALL ASSOCIATIONS® (UEFA®), the PROFESSIONAL GOLF ASSOCIATION® (PGA®), MINOR LEAGUE BASEBALL®, MINOR LEAGUE HOCKEY®, the NATIONAL ASSOCIATION OF STOCK CAR AUTO RACING® (NASCAR®), the NATIONAL COLLEGIATE ATHLETIC ASSOCIATION® (NCAA®) Football and NCAA® Basketball.

18. The method of claim 1, further comprising paying the insured amount to the participant if the insured risk occurs, without the participant notifying an issuer of the insurance policy.

19. The method of claim 1, wherein the request is received via an internet website.

20-24. (canceled)

25. A computer program product comprising software encoded in computer-readable media, for providing insurance to a fantasy sports participant, the software comprising instructions, operable when executed, to:
receive a request from the participant for an insurance policy covering an insured risk for an insured amount; and
provide an insurance policy to the participant covering the insured risk for the insured amount, in exchange for a premium;
wherein the participant owns a fantasy team, and is in a fantasy league,
the insured risk is at least one player on the fantasy team not playing for at least a portion of a fantasy season of the fantasy league, and
an amount of the premium is dependent on underwriting of the insured risk and the insured amount.

26-42. (canceled)
